(19) United States
(12) Patent Application Publication
(10) Pub. No.: US 2017/0132735 A1
(43) Pub. Date: May 11, 2017

(54) ENFORCEMENT SERVICES TECHNIQUES

(71) Applicants: Delv Pty Ltd, Kingston ACT (AU); Search7 Pty Ltd, Mermaid Waters QLD (AU)

(72) Inventors: Rami SMAIR, Brisbane (AU); Samer SMAIR, Brisbane (AU)

(21) Appl. No.: 15/318,442

(22) PCT Filed: Jun. 12, 2015
(86) PCT No.: PCT/AU2015/050321

§ 371 Date: Dec. 13, 2016

(30) Foreign Application Priority Data
Jun. 13, 2014 (AU) 2014902246

(51) Int. Cl. G06Q 50/26; G06Q 10/06

(52) U.S. Cl. CPC G06Q 50/26; G06Q 10/0635

(57) ABSTRACT

The present invention relates to an enforcement services method. The method includes displaying, on a mobile transceiver, information options corresponding to respective information. The method further involves enabling selection of the displayed information options so that corresponding information can be transmitted or received by the transceiver to assist an enforcement officer with duties. Advantageously, the mobile transceiver can assist a travelling enforcement officer with their duties including, for example, vehicle checks, custody check-ins, person checks and restraining orders.

### TECHNICAL FIELD

The present invention generally relates enforcement services techniques. The present invention has particular, although not exclusive application to police security, army or other like law enforcement services.

### BACKGROUND

The reference to any prior art in this specification is not, and should not be taken as an acknowledgement or any form of suggestion that the prior art forms part of the common general knowledge.

Police officers are often travelling as a part of their duties, and are in radio communication with a command center. The command center receives and transmits information to police officers which is both critical and less important. In practice during busy periods, command centers can become swamped with information which hampers the information flow and sharing. Any slowing in the collection and compilation of critical information flow can undesirably impede police officers in effectively performing and completing their duties.

There is an apparent need to improve the provision of information to and from police officers.

### SUMMARY OF THE INVENTION

According to one aspect of the present invention, there is provided an enforcement services method including:
displaying, on a mobile transceiver, information options corresponding to respective information;
enabling selection of the displayed information options so that corresponding information can be transmitted or received by the transceiver to assist an enforcement officer with duties.

Advantageously, the mobile transceiver can assist a travelling enforcement officer with their duties.

The information options may relate to a vehicle check for performing a check on a vehicle. The method may involve receiving information relating to a vehicle subsequent to selecting a vehicle check information option.

The information options may relate to a custody check-in for checking a culprit into custody. The method may involve prompting for, receiving and sending information relating to the check-in.

The information options may relate to a person check for retrieving information relating to a suspect. The method may involve receiving information relating to the suspect subsequent to selecting a person check information option.

The information options may relate to restraining orders. The method may involve monitoring the location of the devices of two parties subject to a restraining order. The method may involve generating an alarm when the devices breach the restraining order.

The information options may relate to recognition. The method may involve recognizing an object (e.g. car, license plate, face) from a captured image subsequent to selecting a recognition information option.

The information options may include an image creation option for creating an image. The method may involve creating an image relating to an object (e.g. wanted person, stolen car, etc.) subsequent to selecting the image creation option.

The method may involve actuating a risk notification relating to the officer. The method may involve notifying a respondent of the risk notification after a predetermined period. The respondent may communicate with the officer via the device or receive images from a camera of the device. The method may involve the officer extending the predetermined period or immediately sending the risk notification. The method may involve setting a risk level associated with the risk notification.

The method may involve tracking the location of the device. The method may involve displaying the tracked location on a map. The method may involve detecting hijacking of the device, and indicating the location of the hijacking. The detecting may involve analyzing parameters of the device (e.g. differences in speed, change in direction, etc.) or parameters of the officer (e.g. age).

The method may involve imposing communication restrictions on officers. The restriction may be based upon geographic location or parameters of the officer (e.g. skill level, rank, age, etc.).

The method may involve displaying the information options responsive to identity validation of the officer. The method may involve logging the activities of the device. The logging may involve logging a tracked location of the device. The method may involve generating a report from the logged activities. The report may display a map indicating incidents.

The information may include displayed images from one or more cameras. The images may be based upon the geographic location of the device.

The method may further involve the device sending a task request for another enforcement officer.

The method may involve a citizen logging an incident. The method may involve determining that the officer can address the incident and notifying the officer of the incident via the device. The determining may be based on geographic location.

The method may involve the step of searching to locate information. The searching may be performed in accordance with a selected option to locate the respective information. The searching may be initiated responsive to a manually selected option or immediate viewing or initiated at a predetermined time (e.g. periodically) and stored for later viewing. The method may involve tagging located information for relevance (e.g. irrelevant, useful, etc.) for filtering.

The searching may involve searching unstructured sources. The unstructured sources may include any one or more of: Books, Documents, Articles; News; Blogs; Wikis; Phone Directories; Business Directories; Social Media.

The searching may involve selecting an entity type. The entity type may include any one of: person, vehicle, group, website, or social media. The method may involve compiling and storing an entity record including information located when searching relating to an entity.

The method may further involve automatically searching for entity information relating to an entity and adding any new information to the record. The method may further involve tagging the entity to receive automatic updates in the record relating to the entity. Reading or writing access to the record may be limited according to access level of the user. One or more persons may be given access to write to the record without being able to read from the record. The method may involve receiving a report relating to the entity.

The method may involve filtering located information; and displaying the filtered information.

The method may involve using voice recognition.

According to another aspect of the present invention, there is provided an enforcement services system including an enforcement person's mobile transceiver configured to:
display information options corresponding to respective information;
enable selection of the displayed information options so that corresponding information can be transmitted or received by the transceiver to assist an enforcement officer with duties.

The system may further include a citizen's computer.

The system may further include at least one command center server for sending and receiving information to and from the transceiver. The system may further include a database for storing information. At least some of the information may be stored in an entity record.

According to another aspect of the present invention, there is provided a mobile transceiver configured to:
display information options corresponding to respective information;
enable selection of the displayed information options so that corresponding information can be transmitted or received by the transceiver to assist an enforcement officer with duties.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic diagram of an enforcement services system in accordance with an embodiment of the present invention;

FIG. 2 is a schematic diagram of a general duties display screen on a police officer's tablet of the system of FIG. 1;

FIG. 3 is a schematic diagram of a vehicle check screen in accordance with an embodiment of the present invention;

FIG. 4a is a schematic diagram of a person check screen in accordance with an embodiment of the present invention;

FIGS. 4b to 4e show screenshots on an officer's tablet when checking a culprit into custody;

FIG. 5 is a schematic diagram of a map showing the location of a tracked device and recommended route to that device in accordance with an embodiment of the present invention;

FIG. 6 is a schematic diagram showing a citizen incident log display screen in accordance with an embodiment of the present invention; and

FIG. 7 is a schematic diagram showing a search results screen in accordance with an embodiment of the present invention.

### DETAILED DESCRIPTION OF PREFERRED EMBODIMENTS

Policing System

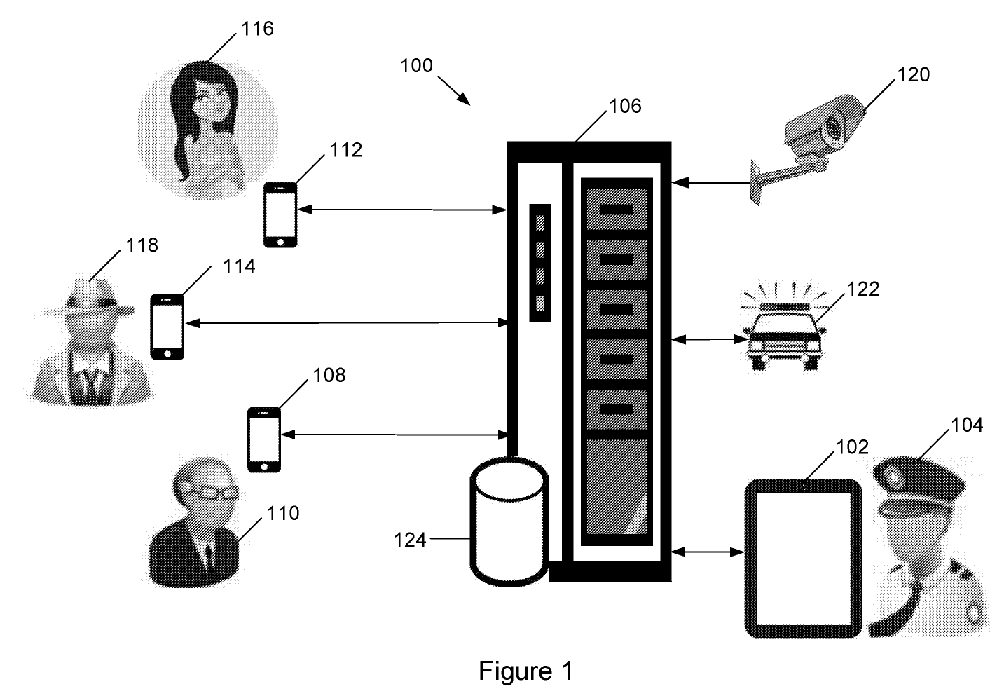

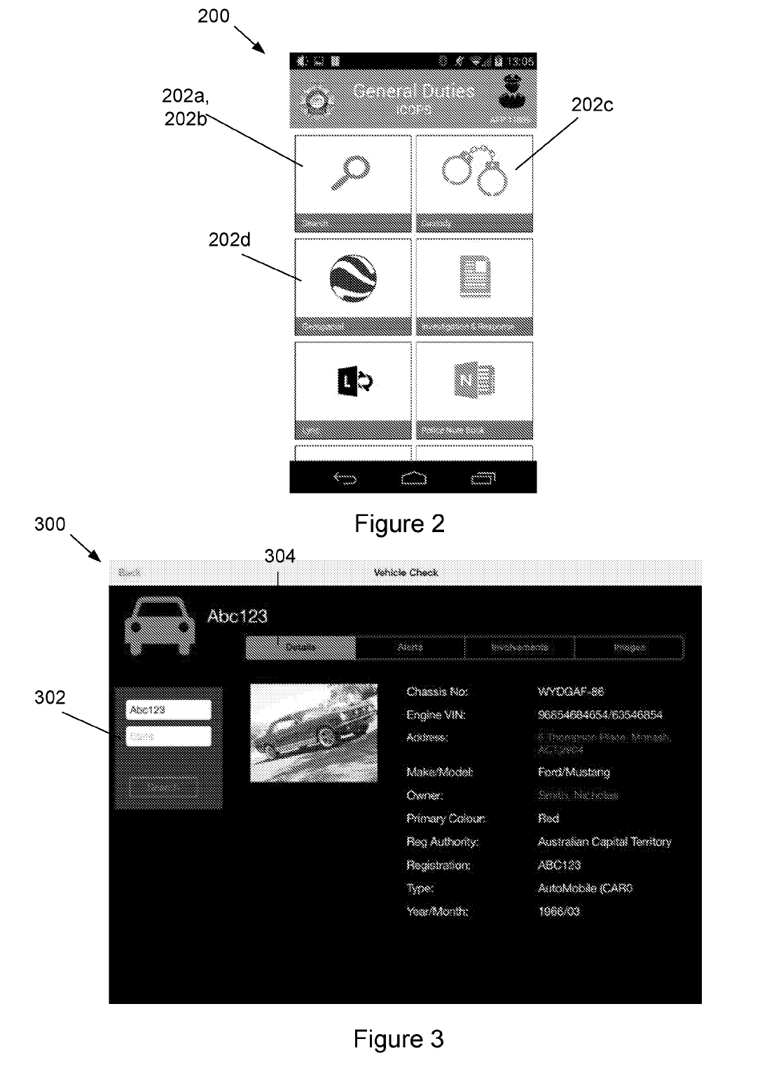

According to an embodiment of the present invention, there is provided a policing (i.e. enforcement services) system 100 as shown in FIG. 1. The system 100 includes a police officer's hand-held tablet 102 (i.e. internet enabled transceiver) running application software (i.e. an App) configured to display a general duties display screen 200 as shown in FIG. 2. The display screen 200 includes information options 202 corresponding to respective information. The tablet 102 enables selection of the displayed information options 202 so that corresponding information can be transmitted or received by the tablet 102 to assist the police officer 102 with his general duties.

Advantageously, the hand-held tablet 102 can assist the travelling police officer 104 with his duties by enabling the real-time transmittal and receipt of information. Provision of real-time information delivers cost savings, time savings and contributes towards a safer community and safer city programs by directly assisting in the prevention and reduction of crime rates and security incidents. Although described below with reference to a single police officer 104, the system 100 typically includes hundreds of police officers 104 and greatly facilitates in the collaborative sharing of information between the mobile officers 104. Further, the hand-held tablet 102 enables the police officer 104 to complete his duties on the move, without requiring the officer 104 to complete duties using other computing devices at the police station.

The system 100 further includes at least one command center server 106 for sending and receiving information to and from the officer's tablet 102. The server 106 is typically located in the police command center. Furthermore, a citizen's computer 108 runs an App enabling a concerned citizen 110 to also transmit and receive information to and from the server 106. However, the citizen 110 is a secondary user and the degree of information transfer by the citizen's computer 110 is naturally somewhat limited when compared with the tablet 102 whereby the officer 104 is a primary user.

The system 100 further includes a wife's smartphone 112 and a husband's smartphone 114, belonging to a respective wife 116 and husband 118 that are subject to a restraining order. Both smartphones 112, 114 can transmit and receive information, including geographic location (e.g. GPS) information, to and from the server 106.

The system 100 further includes surveillance cameras 120 for capturing surveillance images sent to the command center server 106. Police vehicles 122 are also provided and exchange information, including geographic location information, with the server 106. The system 100 further includes a database 124 for storing information. The stored information includes entity records with useful information relating to entities such as the husband 118 or other people, a group, a website or social media.

Each of the system devices 102, 108, 112, 114, 120, 122, 124 can communicate with each other via the server 106 and over a vast network (not shown) including the internet and telephone network.

Policing Examples

A detailed explanation of the functional methods performed using the system 100 is now provided below.

The police officer 104 is typically mobile on the beat with his tablet 102. As the officer 104 encounters various incidents, the officer 104 can use the tablet 102 to display the general duties display screen 200 including information options 202 corresponding to respective information. The officer 104 can select the displayed information options 202 so that corresponding information can be transmitted or received by the tablet 102 to assist the officer 104 with his varied general duties.

The officer 102 may encounter criminals in the course of his duties. Accordingly, the display screen 200 is only displayed responsive to identity validation of the officer 104, by way of a PIN, biometrics, etc., to minimize the possibility of unauthorized access to the information. Furthermore, voice recognition can be used by the officer 102 to select the options 202 which is advantageous when the officer 104 is under duress and unable to type.

Communication restrictions are imposed on the officer's tablet 104 using the system 100. For example, the command center server 106 may lock out tablet's 104 based upon geographic location or parameters of the officer 104 such as skill level, rank or age.

Vehicle Check

The general duties display screen 200 includes vehicle check option 202a for performing a search and check on a vehicle. Upon selection of the vehicle check option 202a, the tablet 102 displays a search input box 302 shown in FIG. 3 enabling search criteria (e.g. registration number) to be entered. In turn, the tablet 102 receives information from the database 124 relating to a vehicle which matches the search criteria. Details relating to the searched vehicle are displayed. A strip of selectable information tabs 304 are provided which when selected enable filtering of information and subsequent display of filtered information.

Person Check

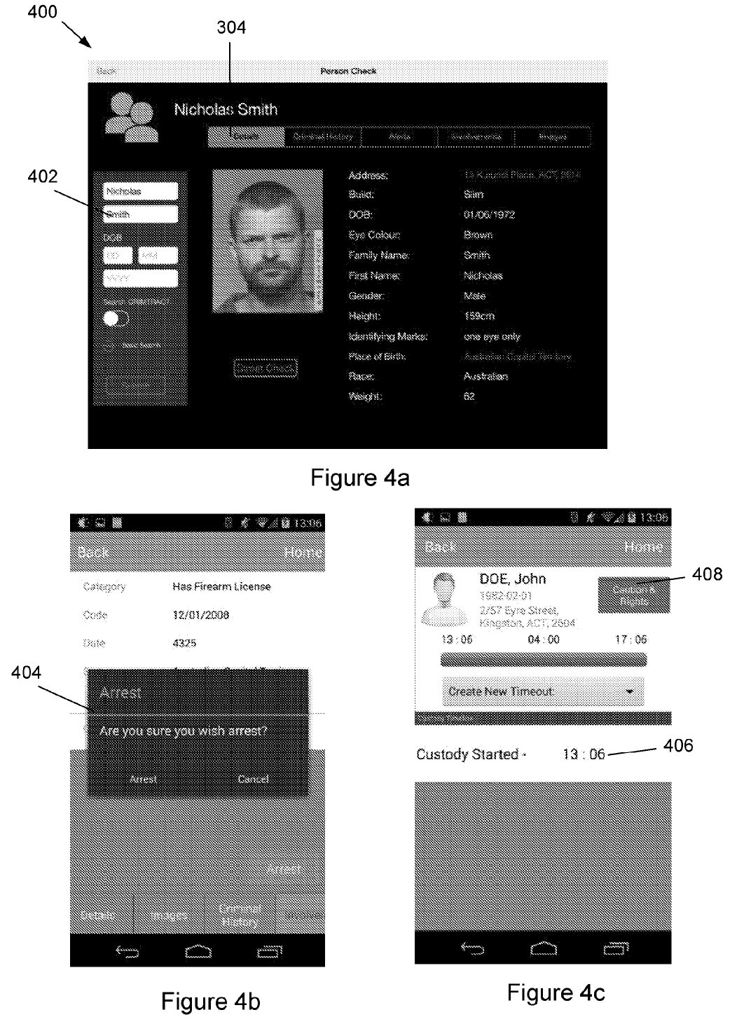

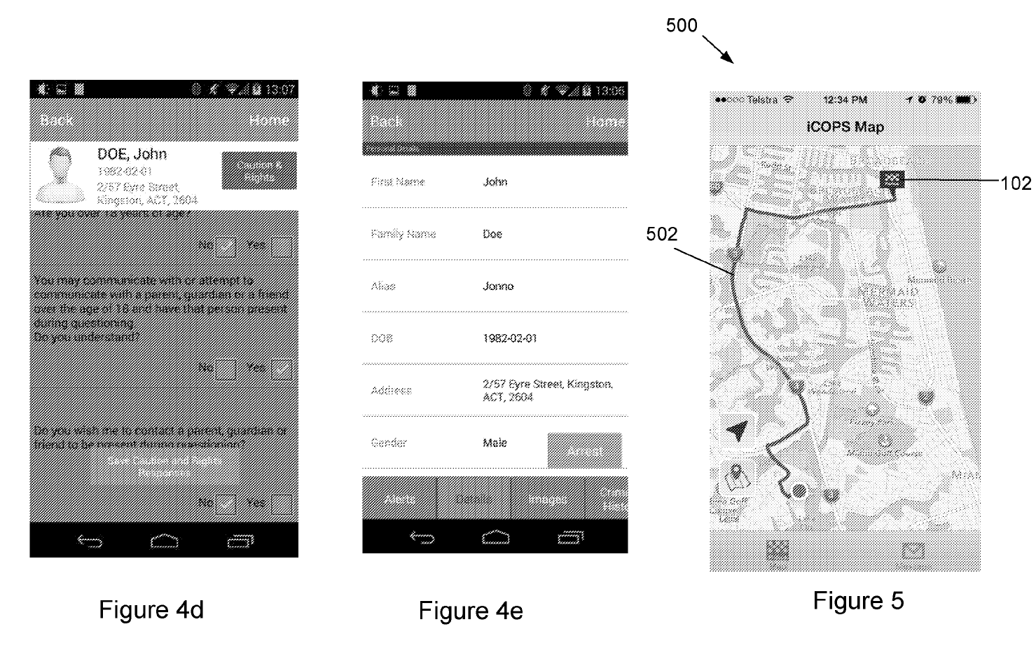

The general duties display screen 200 includes person check option 202b for performing a search and check on a person. Upon selection of the person check option 202b, the tablet 102 displays a person input box 402 shown in FIG. 4a enabling search criteria (e.g. name) to be entered. In turn, the tablet 102 receives information from the database 124 relating to a person 118 which matches the search criteria. Details relating to the searched person are displayed. A strip of selectable information tabs 404 are provided which enable filtering and subsequent display of selected information.

Custody Check-in

Similarly, the general duties display screen 200 can include a custody check-in option 202c for checking a culprit 118 into custody. The tablet 102 prompts for, receives and sends information relating to the check-in to the database 124. Turning to FIG. 4b, the tablet 102 initially displays a box 404 querying the officer 104 as to whether an arrest of the culprit 118 is required. Turning to FIG. 4c, responsive to the officer 104 affirming that an arrest is required, the tablet 102 logs the custody procedure including the automatic logging of the initial custody time 406. The officer 104 can select the displayed caution and rights actuator 408 to initiate the guidance procedure for cautioning and reading of rights to the culprit 118. Turning to FIG. 4d, the tablet 102 then guides the officer through the required cautioning and reading of rights to the culprit 118, by providing queries and logging responses relating to the culprit 118 which can then be saved in the database 124. Turning to FIG. 4e, the tablet displays a details screen relating to the culprit 118 (similar to FIG. 4a above). The details screen can either be created by the officer 104 during arrest or received from the database 124 if already existing.

Restraining Order Enforcement

Similarly, the general duties display screen 200 can include a restraining order option (not shown) for enforcing restraining orders. In this manner, the command center server 106 monitors the geographic location (via GPS) of the phones 112, 114 of a couple 116, 118 subject to a restraining order. In the event that the couple 116, 118 breach the order by coming within a predetermined distance, the server 106 generates and sends an alarm to the tablet 102. In turn, the officer 104 notified of the alarm can view the location of the phones 112, 114 on a displayed map and take appropriate action.

Object Recognition

Similarly, the general duties display screen 200 can include an object recognition option (not shown) for recognizing objects captured with the tablet 102. Upon selection of the object recognition option, the command center server 106 receives the captured image and performs image processing to recognize an object (e.g. car, license plate, face). In turn, the tablet 102 receives information from the database 124 relating to the recognized object to assist the officer 104.

Image Creation

Similarly, the general duties display screen 200 can include an image creation option (not shown) for creating images with the tablet 102. The officer 104 can use the tablet 102 to create an image relating to an object (e.g. wanted person, stolen car, etc.) subsequent to selecting the image creation option. In turn, the server 106 receives the created image and can store it in the database 124 or post the image to other officer's tablets 102 for consideration.

Risk Notification

Similarly, the general duties display screen 200 can include a risk notification option (not shown) for actuating a risk notification relating to the officer 104 in a potentially dangerous situation. Upon selecting the risk notification option, the officer 104 also sets a risk level (e.g. LOW, HIGH, etc) associated with the risk notification and the tablet 102 sends a risk request to the server 106. The server 106 begins a countdown for a predetermined period inversely related to the received risk level (i.e. the higher the risk, the shorter the period). Upon the expiry of the period, the server 106 sends an alarm with the last known position of the officer's tablet 102 to another officer's tablet for response. The real-time position of the officer's tablet 102 is displayed on a map 500 on the respondent's tablet 102 as shown in FIG. 5, along with the recommended route 502 to reach the respondent's tablet 102. The respondent can communicate with the officer 102 via his tablet 102 and receive images from a camera of the tablet 102.

The officer 104 can cancel, extend or reduce the risk notification countdown as required to respectively avoid, delay or speed up notification to the respondent as the officer 104 re-evaluates the risk he faces.

The server 106 tracks the location of the tablet 102 and updates the details on the map 500 displayed on the respondent's tablet. The server 106 can detect hijacking of the tablet 102 (e.g. during a struggle), and indicates to the respondent the location of the hijacking. The hijacking detection involves analyzing parameters of the tablet 102 (e.g. differences in speed, change in direction, etc.) or parameters of the officer 104 (e.g. age).

The officer 104 can also send an URGENT risk level with no countdown period for immediate response by the respondent.

Reporting

The server 106 logs the activities of the tablet 102 in database 124. In this manner, the officer 104 can enter activity notes for logging in the database 124. The GPS location of the tablet 102 is also tracked and logged in the database 124. The logged activities can be shared with other officers 104 to improve response times.

The server 106 can generate a report from the logged activities for accountability or to evaluate performance. The report can include a displayed map indicating any logged incidents.

Surveillance Cameras

The general duties display screen 200 can include a surveillance camera option (not shown) for receiving streamed images on the tablet 102 from surveillance cameras 120, police vehicles 122, officer borne cameras or other cameras. Upon selection of the camera option, the server 106 streams images from cameras 120 proximal to the geographic location of the tablet 102. The camera feeds can be automatically displayed on the tablet in accordance with the location of a monitored person 118 determined by their phone 114. For example, a middle displayed camera feed may always be the feed from the camera 120 located proximal to the person 118.

Citizen Incident Log

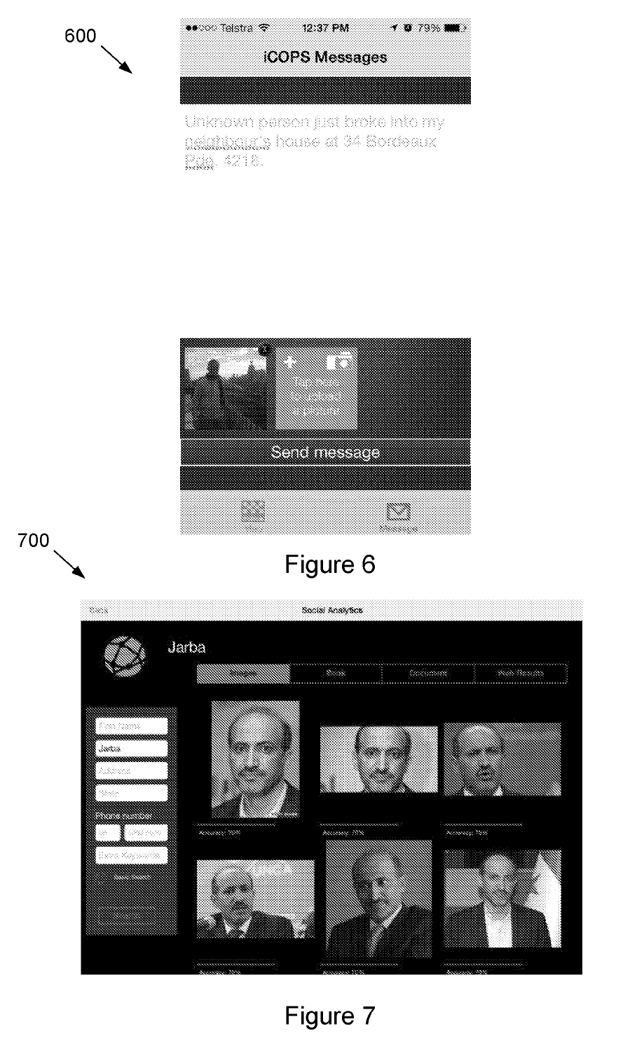

Similarly, the citizen 110 can use their phone 108 to log an incident (e.g. house break-in) with the server 106 as shown in the display screen 600 of FIG. 6. In turn, the server 106 determines that the officer 104 can address the incident, as his tablet 102 is in close geographic proximity to the incident, and notifies the officer 104 to respond to the incident via the tablet 102. The citizen 100 can attach a message and captured image to the logged incident, and use the phone 108 to communicate (via messaging, video call, phone call, etc.) with the responding officer's tablet 102.

The server 106 can also automatically route the incident to the most appropriate officers 102 based upon the risk level to the citizen 100, urgency of the incident, number of available officers 104, and nearest police stations or vehicles 122 to the incident. The routing can also be manually overridden. Multiple officers 104 may be assigned to attend to the incident, with the closer officer to the incident being designated as the primary respondent and an officer further away being designated as a backup respondent.

Furthermore, the citizen's phone 108 can be tracked by the responding officer 104, via server 106, using a map displayed on the tablet 102 showing the location of and recommended route to the citizen's phone 108 (similar to FIG. 5 above). Any hijacking of the phone 108 can be detected and displayed as previously described above. The citizen can also view a map showing the location of the tablet 102, and any proximal police stations.

A group of citizens 110 (e.g. living on the same street) can also log incidents and discuss security issues on a forum hosted by the server 106, without involvement of the officer 104. The citizens 110 may need to be authorized to join the group, and can be blacklisted. The App running on the citizen's phone 108 may be camouflaged (i.e. hidden) until the citizen 110 authenticates his identity with a PIN. In this manner, citizen's acting as informants are less likely to be exposed.

Task Request

The tablet 102 can send a task request to the server 106 for actioning by another enforcement officer 104. In turn, the server 106 forwards the task request to the other enforcement officer's tablet. The server can route the task in a similar manner to the citizen incident described above.

Street Check

The tablet 102 enables capture of entity information and logging the incident in the database 124. For example, the officer 104 may record a random person's details, captured image, location, the time and any other relevant notes in the database 124.

Advanced Searching

The tablet 102 can display a searching option 202d so that the officer 104 can locate information included in database 124 when on the move. The searching is initiated responsive to the officer 104 manually selecting the option 202d and entering a search string so that the results are available for immediate viewing as shown in the results screen 700 of FIG. 7. Information, including in the database 106, is continually changing and therefore the officer 104 can initiate an ongoing search by the server 106 at a predetermined time (e.g. periodically) and the results can be stored in the database 106 for later viewing on the tablet 102.

The searching involves searching structured databases as well as unstructured sources. The unstructured sources may include any one or more of: Books, Documents, Articles; News; Blogs; Wikis; Phone Directories; Business Directories; Social Media.

The searching involves selecting an entity type. The entity type includes any one of: a person, a vehicle, a group, a website, or social media. The method involves compiling and storing in database 124 an entity record including information located when searching relating to an entity.

The searching can further involve automatically searching for entity information relating to an entity, and adding any new information to the record. The officer 104 can tag the entity to receive, on the tablet 102, automatic updates in the record relating to the entity. The updates may be provided conditional to an intelligence value changing by a predetermined amount or when any data has changed. Reading or writing access to the entity record is limited according to access level of the user (e.g. officer 104).

One or more persons such as concerned citizens 110 or informants can be given access to write to the record to provide leads in an unsolved case, without being able to read from the record. The officer 104 can use his tablet 102 to receive a report relating to the entity that is generated by the server 106.

The officer 104 can peruse the displayed search results on the tablet 102, and tag located information for relevance (e.g. irrelevant, useful, etc.) for storage in the entity record and to facilitate later filtering. Known associates of the searched entity can be provided as a result of the search.

A person skilled in the art will appreciate that many embodiments and variations can be made without departing from the ambit of the present invention.

In one embodiment, a similar map 500 can be displayed on the citizen's smartphone 108 with the route 502 leading from the smartphone 108 to a safe haven (e.g. police station).

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘can embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

The claims defining the invention are as follows:

1. An enforcement services method including the steps of:
displaying, on a mobile transceiver, information options corresponding to respective information;
enabling selection of the displayed information options so that corresponding information can be transmitted or received by the transceiver to assist an enforcement officer with duties.

2. An enforcement services method as claimed in claim 1, wherein the information options relate to a vehicle check for performing a check on a vehicle.

3. An enforcement services method as claimed in claim 2, involving receiving information relating to a vehicle subsequent to selecting a vehicle check information option.

4. An enforcement services method as claimed in claim 1, wherein the information options relate to a custody check-in for checking a culprit into custody.

5. An enforcement services method as claimed in claim 4, involving prompting for, receiving and sending information relating to the check-in.

6. An enforcement services method as claimed in claim 1, wherein the information options relate to a person check for retrieving information relating to a suspect.

7. An enforcement services method as claimed in claim 6, involving receiving information relating to the suspect subsequent to selecting a person check information option.

8. An enforcement services method as claimed in claim 1, wherein the information options relate to restraining orders.

9. An enforcement services method as claimed in claim 8, involving monitoring the location of devices of two parties subject to a restraining order.

10. An enforcement services method as claimed in claim 9, involving generating an alarm when the devices breach the restraining order.

11. An enforcement services method as claimed in claim 1, wherein the information options relate to recognition.

12. An enforcement services method as claimed in claim 11, involving recognizing an object from a captured image subsequent to selecting a recognition information option.

13. An enforcement services method as claimed in claim 1, wherein the information options include an image creation option for creating an image.

14. An enforcement services method as claimed in claim 13, involving creating an image relating to an object subsequent to selecting the image creation option.

15. An enforcement services method as claimed in claim 1, further involving actuating a risk notification relating to the officer.

16. An enforcement services method as claimed in claim 15, involving notifying a respondent of the risk notification after a predetermined period.

17. An enforcement services method as claimed in claim 16, involving the respondent communicating with the officer via the device or receiving images from a camera of the device.

18. An enforcement services method as claimed in claim 16, involving the officer extending the predetermined period or immediately sending the risk notification.

19. An enforcement services method as claimed in claim 15, involving setting a risk level associated with the risk notification.

20. An enforcement services method as claimed in claim 1, involving tracking the location of the device.

21. An enforcement services method as claimed in claim 20, involving displaying the tracked location on a map.

22. An enforcement services method as claimed in claim 1, involving detecting hijacking of the device, and indicating the location of the hijacking.

23. An enforcement services method as claimed in claim 22, wherein the detecting involves analyzing parameters of the device or parameters of the officer.

24. An enforcement services method as claimed in claim 1, involving imposing communication restrictions on officers.

25. An enforcement services method as claimed in claim 24, wherein the restrictions are based upon geographic location or parameters of the officer.

26. An enforcement services method as claimed in claim 1, involving displaying the information options responsive to identity validation of the officer.

27. An enforcement services method as claimed in claim 1, involving logging the activities of the device.

28. An enforcement services method as claimed in claim 27, wherein the logging involves logging a tracked location of the device and generating a report from the logged activities, the report displaying a map indicating incidents.

29. An enforcement services method as claimed in claim 1, wherein the information includes displayed images from one or more cameras.

30. An enforcement services method as claimed in claim 29, wherein the images are based upon the geographic location of the device.

31. An enforcement services method as claimed in claim 1, further involving the device sending a task request for another enforcement officer.

32. An enforcement services method as claimed in claim 1, involving a citizen logging an incident.

33. An enforcement services method as claimed in claim 32, involving determining that the officer can address the incident and notifying the officer of the incident via the device.

34. An enforcement services method as claimed in claim 33, wherein the determining is based on geographic location.

35. An enforcement services method as claimed in claim 1, further involving the step of searching to locate information.

36. An enforcement services method as claimed in claim 35, wherein the searching is performed in accordance with a selected option to locate the respective information.

37. An enforcement services method as claimed in claim 35, wherein the searching is initiated responsive to a manually selected option or immediate viewing or initiated at a predetermined time and stored for later viewing.

38. An enforcement services method as claimed in claim 35, involving tagging located information for relevance for filtering.

39. An enforcement services method as claimed in claim 35, wherein the searching involves searching unstructured sources.

40. An enforcement services method as claimed in claim 35, wherein the searching involves selecting an entity type.

41. An enforcement services method as claimed in claim 35, involving compiling and storing an entity record including information located when searching relating to an entity.

42. An enforcement services method as claimed in claim 41, further involving automatically searching for entity information relating to an entity and adding any new information to the record.

43. An enforcement services method as claimed in claim 42, further involving tagging the entity to receive automatic updates in the record relating to the entity.

44. An enforcement services method as claimed in claim 41, involving filtering located information, and displaying the filtered information.

45. An enforcement services system including an enforcement person's mobile transceiver configured to:
display information options corresponding to respective information;
enable selection of the displayed information options so that corresponding information can be transmitted or received by the transceiver to assist an enforcement officer with duties.

46. A mobile transceiver configured to:
display information options corresponding to respective information;
enable selection of the displayed information options so that corresponding information can be transmitted or received by the transceiver to assist an enforcement officer with duties.
